(19) United States
(12) Patent Application Publication
(10) Pub. No.: US 2012/0057326 A1
(43) Pub. Date: Mar. 8, 2012

(54) Backlight Module and Optical Component Thereof

(75) Inventors: Weiwei Zheng, Guangdong (CN); Yicheng Kuo, Guangdong (CN); Jie Ren, Guangdong (CN)

(73) Assignee: Shenzhen China Star Optoelectronics Technology Co., Ltd., Shenzhen, Guangdong (CN)

(21) Appl. No.: 12/996,881

(22) PCT Filed: Nov. 15, 2010
(86) PCT No.: PCT/CN10/78757

§ 371 Date: Dec. 8, 2010

(30) Foreign Application Priority Data
Sep. 3, 2010 (CN) 201010278761.5

(51) Int. Cl. F21V 9/16

(52) U.S. Cl. 362/84

(57) ABSTRACT

The present invention provides a backlight module and an optical component thereof. The optical component comprises a substrate, a fluorescent layer, and a microstructure. The substrate has a first surface and a second surface. The fluorescent layer is applied on the first surface of the substrate, and the microstructure is formed on the second surface of the substrate. The fluorescent layer and the microstructure are set on two side of the substrate, respectively, so that at least one incident beam is optically refracted or scattered by the microstructure to uniformly penetrate through the microstructure and the substrate. Thus, a blue backlight which penetrate through the fluorescent layer and a yellow backlight which is excited from the fluorescent layer are mixed for ensuring the backlight module to provide a white backlight with uniform brightness and high brilliance.

### FIELD OF THE INVENTION

The present invention relates to a backlight module and an optical component thereof, and more particularly to an optical component having one surface which is applied a fluorescent layer and the other surface which is formed with a microstructure for generating uniform brightness, enhancing the brilliance, and providing an effect of light mixture and to a backlight module having the optical component.

### BACKGROUND OF THE INVENTION

A liquid crystal display (LCD) is a kind of flat panel display (FPD), which shows images by the property of liquid crystal material. Comparing with other display devices, the liquid crystal display has the advantages in lightweight, compactness, low driving voltage and low power consumption, and thus has already become the mainstream produce in the whole consumer market. However, the liquid crystal material of the liquid crystal display cannot emit light by itself, and must depend upon an external light source. Thus, the liquid crystal display further has a backlight module to provide the needed light source.

Generally, the backlight module can be divided into two types, and a main function of the backlight module is providing the liquid crystal display a backlight with high brilliance and uniform brightness. Thus, whether an optical component of the backlight module can be lightweight, whether the external light source can be more uniform and higher brilliance and whether the backlight module can meet the needs of energy saving has already become the focus in current research and development. Therefore, combining semiconductor light-emitting devices with optical components such as diffusing plates in the backlight module has already become the main trend. The advantages are that: comparing to a cold cathode fluorescent lamp (CCFL), the semiconductor light-emitting devices have more advantages in power saving, longer lifetime, and smaller and more compact. The currently existing semiconductor light-emitting device particularly uses a light-emitting diode to emit light beams, and the light-emitting diode is mostly in a form of chip and is fixed on a fixed plate of a backlight module. A diffusing plate of the optical component not only provides the backlight with high uniform brightness, but also has functions in improving the brilliance and the brightening.

Referring now to FIG. 1, a schematic view of an existing backlight module is illustrated, wherein the backlight module 10 roughly comprises a diffusing plate 11, a fluorescent layer 12, a fixed plate 13, and a plurality of light-emitting diode chips 14. The fluorescent layer 12 is formed by applying fluorescence powder on a surface 111 of the diffusing plate 11; the light-emitting diode chips 14 are fixed on a surface 131 of the fixed plate 13, and the surface 111 of the diffusing plate 11 and the surface 131 of the fixed plate 13 is opposite to each other. The light-emitting diode chips 14 are used to emit at least one blue incident beam. When the at least one blue incident beams are emitted to the fluorescent layer 12 which on the diffusing plate 11, a part of the at least one blue incident beams may excite the fluorescence powder of the fluorescent layer 12 to radiate a first beam that penetrates through the diffusing plate 11, and the other part of the at least one blue incident beams directly penetrates through the fluorescent layer 12 and the diffusing plate 11 to be a second beam, wherein the first beam is a yellow beam and the second beam still is the blue beam. The first beam and the second beam are mixed into a white beam at the other side of the diffusing plate 11 as a light source of the backlight module 10.

Nevertheless, beams of different colors have different indices of refraction. Referring to FIG. 2A and FIG. 2B, a bidirectional reflection distribution functions (BTDF) of yellow beams that are radiated by different incident angles of the blue incident beams used to excite the fluorescent layer 12 and a BTDF of blue beams that come from different incident angles of the blue incident beams directly penetrating through the fluorescent layer 12 and the diffusing plate 11 are illustrated, respectively. Comparing FIG. 2A and FIG. 2B, it can be known that the bidirectional reflection distribution functions of the first beam and the second beam are inconsistent. The bidirectional reflection distribution function of the first beam shows a similar Lambert distribution in accordance with the different incident angles, and the bidirectional reflection distribution function of the second beam shows a narrow half-wave width in accordance with the different incident angles. In other words, the first beam and the second beam have different intensity in the bidirectional reflection distribution functions due to the different incident angles, and, that is, the white beam is mixed up the different proportions of the first beam and the second beam in different visual angles. Thus, if the liquid crystal display adopted the backlight module 10 as the light source, chromaticity and tinge of the liquid crystal display may be inconsistent in the different visual angles, so that image quality will be considerably affected.

As a result, it is necessary to provide an optical component for the diffusing plate of the backlight module to solve the problems of the chromaticity and the tinge that exist in the conventional technology.

### SUMMARY OF THE INVENTION

A primary object of the present invention is to provide a backlight module and an optical component thereof, comprising a substrate, a fluorescent layer and a microstructure, wherein the substrate has a first surface and a second surface; the fluorescent layer is applied on the first surface of the substrate; and the microstructure is formed on the second surface of the substrate; wherein the fluorescent layer and the microstructure are formed on two side of the substrate, respectively, for at least one incident beam to be optically refracted or scattered by the microstructure, so as to uniformly penetrate through the microstructure and the substrate. Thus, the fluorescent layer will be excited, and finally a blue backlight which directly penetrates through the fluorescent layer and a yellow backlight which is exited from the fluorescent layer are mixed for ensuring the backlight module to provide a white backlight with uniform brightness and high brilliance.

A secondary object of the present invention is to provide a backlight module and an optical component thereof, the microstructure further comprises a specific patterned surface which has textured patterns, granular patterns, prisms, microlens, or the combination thereof.

A third object of the present invention is to provide a backlight module and an optical component thereof, wherein the at least one incident beam is a blue beam, and a part of the blue beam is used to excite the fluorescent layer to radiate a yellow backlight, and the other part of the at least one blue beam directly penetrates through the microstructure, the substrate and the fluorescent layer to be a blue backlight. Finally, the yellow backlight and the blue backlight are mixed to be a white backlight. During the blue beam penetrates through the optical component, the blue beam is optically refracted or scattered by the microstructure, so that it is advantageous to enhance uniform brightness and high brilliance of the white backlight.

To achieve the above object, the present invention provides a backlight module, wherein the backlight module comprises: an optical component comprises: a substrate having a first surface and a second surface; a fluorescent layer applied on the first surface of the substrate; and a microstructure forming on the second surface of the substrate; a fixed plate; and at least one semiconductor light-emitting device fixing on the fixed plate for emitting at least one incident beam, wherein the at least one incident beam to be optically refracted or scattered by the microstructure for enhancing uniform brightness and brilliance, so that the at least one incident beam can uniformly penetrates through the microstructure and the substrate in turn, and then penetrate through the fluorescent layer or excites the fluorescent layer.

Furthermore, the present invention provides another optical component, wherein the optical component comprises: a substrate having a first surface and a second surface; a fluorescent layer applied on the first surface of the substrate; and a microstructure forming on the second surface of the substrate for at least one incident beam to be optically refracted or scattered, so that the at least one incident beam uniformly penetrates through the microstructure and the substrate in turn, and then penetrates through the fluorescent layer or excites the fluorescent layer.

In one embodiment of the present invention, the microstructure further comprises a patterned surface which is formed by embossing process, applying, diffusion, molding or precision machining and has textured patterns, granular patterns, prisms, microlens, or the combination thereof.

In one embodiment of the present invention, the at least one semiconductor light-emitting device is a light-emitting diode chip, such as a blue light-emitting diode chip.

In one embodiment of the present invention, the light-emitting diode chip further comprises a molding compound.

In one embodiment of the present invention, the substrate is a diffuser plate, a diffuser sheet, or a light concentrating sheet.

In one embodiment of the present invention, the fluorescent layer contains at least one kind of fluorescence powder, such as a yellow fluorescence powder.

In one embodiment of the present invention, the fixed plate is a back plate or a light source base.

Comparing to the existing technology, the backlight module and the optical component thereof uses the blue beams as the incident beams, wherein a part of the blue beams penetrate through the optical component to form the blue backlight, and a part of the blue beams excites the fluorescent layer so that the fluorescent layer radiates the yellow backlight. Finally, the blue backlight and the yellow backlight are mixed into the white backlight. Because of the blue beams is already optically refracted or scattered during penetrating through the microstructure, the brightness of the mixed white backlight will be more uniform and the brilliance thereof will be substantially enhanced.

### DESCRIPTION OF THE DRAWINGS

FIG. 1 is a schematic view of the existing backlight module;

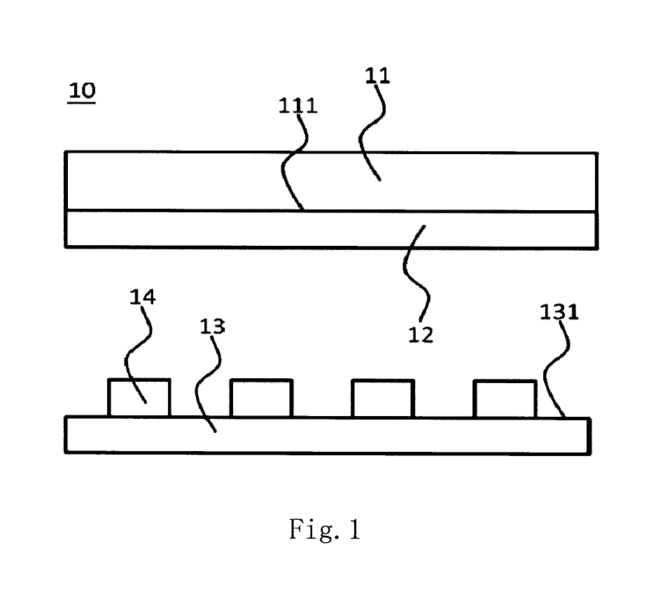

FIG. 2A is the bidirectional reflection distribution function (BTDF) of the yellow beams that are radiated by different incident angles of the blue incident beams used to excite the fluorescence powder in the existing backlight module; wherein the X-axis is the tilted angles) (° of the beams emitted from the surface, and the Y-axis is the value of the BTDF (Sr−1);

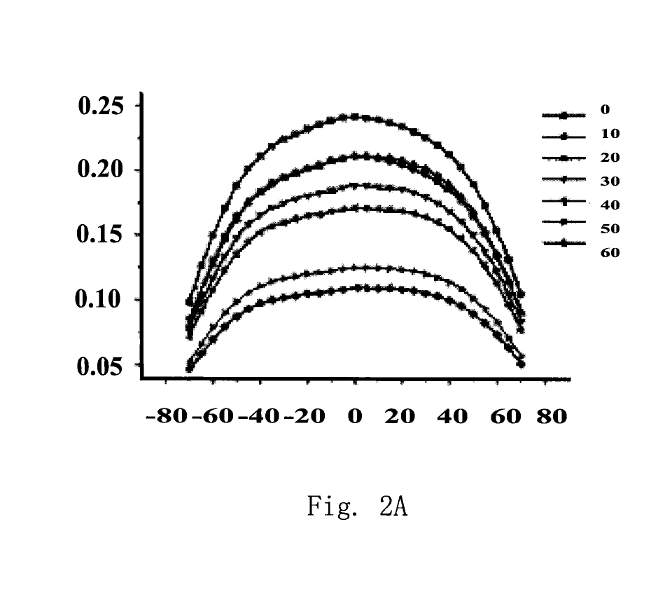

FIG. 2B is the bidirectional reflection distribution function of the blue beams that come from the different incident angles of the blue incident beams directly penetrating through the fluorescence powder and the diffusing plate in the existing backlight module;

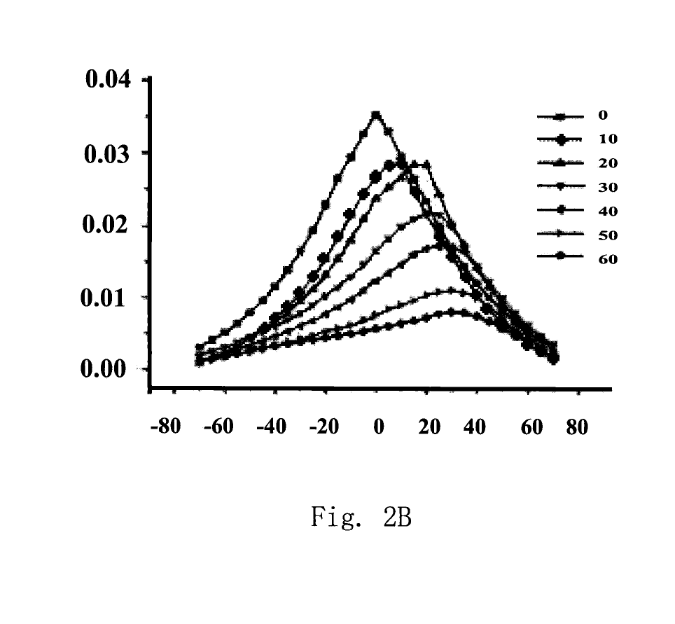

FIG. 3 is a schematic view of the backlight module and the optical component thereof according to a preferred embodiment of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

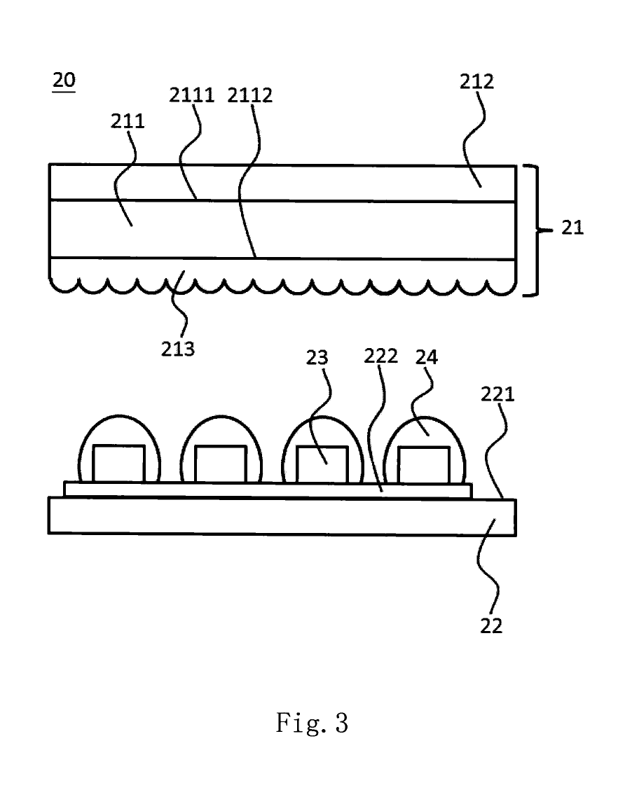

Referring now to FIG. 3, a schematic view of a backlight module and an optical component thereof according to a preferred embodiment of the present invention is illustrated, wherein the backlight module 20 of the preferred embodiment of the present invention is mainly applied to the field of a liquid crystal display (LCD), and the backlight module 20 comprises an optical component 21, a fixed plate 22, and at least one semiconductor light-emitting device 23. The optical component 21 further comprises a substrate 211, a fluorescent layer 212, and a microstructure 213. The foregoing components of the present invention will be described more detailed hereinafter.

Referring to FIG. 3, in the preferred embodiment of the present invention, the substrate 211 of the optical component 21 of the backlight module 20 is mainly made of optical resin composite material, such as polycarbonate (PC), polymethyl methacrylate (PMMA), methylmetahacrylate styrene (MS), cyclo-olefin polymer (COP), and so on. The substrate 211, which further comprises a first surface 2111 and a second surface 2112 opposite to the first surface 2111, uses to cause at least one incident beam to form an uniform backlight by optical refraction or scattering, and the substrate 211, and thus has an effectiveness in enhanced brightness. In the preferred embodiment, the substrate 211 may be a diffuser plate or a diffuser sheet, a light concentrating sheet, or the combined of any two thereof. The fluorescent layer 212 is coated on the first surface 2111 of the substrate 211 by applying or plating. While the fluorescent layer 212 is excited by a part of the incident beams, the fluorescent layer 212 will radiate at least one radial beam with a specific color and a specific wavelength in accordance with material properties thereof. In the preferred embodiment, the fluorescent layer 212 contains at least one kind of fluorescence powder, and the best choice of the fluorescence powder may be preferably a yellow fluorescence powder, such as yttrium aluminum garnet (YAG).

Referring still to FIG. 3, in the preferred embodiment of the present invention, the microstructure 213 has a specific patterned surface for the incident beams to be optically refracted or scattered, wherein the specific patterned surface is come from calculation of geometrical optics in optical refractive indexes and optical pathways in accordance with optical properties of the incident beams and material properties of the microstructure 213. The specific patterned surface of the microstructure 213 may be formed by embossing process, applying, diffusion, molding or precision machining to form textured patterns, granular patterns, prisms, microlens, or the combination thereof. The microstructure 213 is formed on the second surface 2112 of the substrate 211. When the incident beams emit to the microstructure 213, the incident beams may to be optically refracted or scattered in accordance with the material properties and surface shapes of the microstructure 213 and wavelengths and colors of the incident beams to change pathways of the incident beams by convergence or divergence. By processes of optical refraction or scattering, the incident beams which penetrate through the first surface 2111 and the second surface 2112 of the substrate 211 and the fluorescent layer 212 may form a backlight with high brilliance and uniform brightness.

Referring to FIG. 3 again, in the preferred embodiment of the present invention, the fixed plate 22 has a surface 221 and a carrier 222 that is fixed to the surface 221. The surface 221 of the fixed plate 22 and the second surface 2112 of the substrate 211 are opposite to each other, and the at least one semiconductor light-emitting device 23 is firmly installed on the carrier 222 on the surface 221 of the fixed plate 22, for emitting the incident beams toward the second surface 2112 of the substrate 211, wherein the at least one semiconductor light-emitting device 23 is electrically connected to the carrier 222 by a plurality of leading wires (non-shown) or a plurality of bumps (non-shown), and the at least one semiconductor light-emitting device 23 also can be covered by a molding compound 24 which is made of a transparent resin material. In the preferred embodiment, the fixed plate 22 may be preferably a back plate or a light source base, and the at least one semiconductor light-emitting device 23 may be preferably a light-emitting diode (LED) chip, such as a blue light-emitting diode chip, but not limited thereto.

Continuing to referring to FIG. 3, the at least one semiconductor light-emitting device 23 is used to emit the incident beams, and the preferred embodiment may adopt a blue light-emitting diode chip to provide at least one blue incident beam. When the blue incident beams are emitted from the at least one semiconductor light-emitting device 23 to the microstructure 213 on the second surface 2112 of the substrate 211, the blue incident beams may be optically refracted or scattered in accordance with the material properties and the surface shapes of the microstructure 213 to change the pathways of the blue incident beams. A first blue beam of the blue incident beams penetrate through the microstructure 213, the first surface 2111 and the second surface 2112 of the substrate 211 in turn by optical refraction or scattering, and then the first blue beam excites the fluorescence powder of the fluorescent layer 212 to radiate a radial beam with a specific color and a specific wavelength in accordance with the material properties of the fluorescent layer 212. For example, the fluorescence powder of the fluorescent layer 212, which is adopted in the preferred embodiment, will radiate a yellow beam after the fluorescence powder was excited by the first blue beam. Because of the first blue beam, which excites the fluorescent layer 212, has already become a backlight with the uniform brightness and high brilliance in accordance with the material properties and the surface shapes of the microstructure 213, the radial beam which is radiated by the fluorescent layer 212 may be a yellow backlight with the uniform brightness and high brilliance. In addition, a second blue beam of the at least one blue incident beam is optically refracted or scattered in accordance with the material properties and the surface shapes of the microstructure 213, and then directly penetrates through the microstructure 213, the first surface 2111 and the second surface 2112 of the substrate 211, and the fluorescent layer 212 in turn, to form a blue backlight with uniform brightness and high brilliance. Finally, the yellow backlight radiated from the fluorescent layer 212 and the blue backlight directly penetrating through the fluorescent layer 212 are uniformly mixed to form a white backlight for being used as a light source of the backlight module 20.

Moreover, referring to FIG. 3, the advantages of the foregoing features of the embodiments of the present invention are that: the backlight module 20 and the optical component 21 thereof are used to cause the incident beams from different incident angles to occur the optical refraction or the scattering by the microstructure 213 having the specific patterned surface, and then to change the optical pathways of the incident beams for the optical convergence or divergence for forming the white backlight with the uniform brightness and high brilliance. Therefore, the backlight module 20 can provide the light source with smaller chromaticity in the visual angles for the liquid crystal display for enhancing the image quality of the liquid crystal display. The specific patterned surface is come from the optical designs and the geometrical optics and according to calculating the wavelengths of the incident beams, the material properties of the microstructure 213, the optical refractive indexes, and the optical pathways, so that the microstructure 213 may obtain the specific patterned surface that is matched with the wavelengths of the at least one incident beam emitted from the at least one semiconductor light-emitting device 23. Furthermore, the specific patterned surface of the microstructure 213 may be formed by embossing process, applying, diffusion, molding, or precision machining to form textured patterns, granular patterns, prisms, microlens, or the combination thereof.

Finally, referring to FIG. 3, the other feature of the embodiments of the present invention is that: the at least one incident beam is optical refracted or scattered by the specific patterned surface of the microstructure 213 and then to form the backlight with the uniform brightness and high brilliance, wherein a first backlight of the backlight directly penetrates through the fluorescent layer 212 and keeping the original wavelength, color, uniformity, and brilliance, and wherein a second backlight of the backlight excites the fluorescent layer 212 so that the fluorescent layer 212 radiates a radiated backlight. The second backlight which uses to excite the fluorescent layer 212 has the uniform brightness and the high brilliance, while the radiated backlight which was radiated from the fluorescent layer 212 also has the characteristics in the uniform brightness and the high brilliance. Hence, the white backlight that is mixed by the first backlight penetrated through the fluorescent layer 212 and the radiated backlight radiated from the fluorescent layer 212 has the characteristics in the uniform brightness and the high brilliance as well.

The present invention has been described with a preferred embodiment thereof and it is understood that many changes and modifications to the described embodiment can be carried out without departing from the scope and the spirit of the invention that is intended to be limited only by the appended claims.

1. A backlight module, characterized in that: the backlight module comprises:
an optical component comprising:
a substrate having a first surface and a second surface which is opposite to the first surface;
a fluorescent layer formed on the first surface of the substrate; and
a microstructure formed on the second surface of the substrate;
a fixed plate; and
at least one semiconductor light-emitting device fixing on the fixed plate for emitting at least one incident beam;
wherein the at least one incident beam is optically refracted or scattered by the microstructure, so that the at least one incident beam uniformly penetrates through the microstructure and the substrate in turn, and then penetrates through the fluorescent layer or excites the fluorescent layer; and
wherein the fixed plate is a back plate or a light source base; the at least one semiconductor light-emitting device is a light-emitting diode chip; the at least one incident beam is a blue beam; and the fluorescent layer is a yellow fluorescent layer.

2. The backlight module according to claim 1, characterized in that: the microstructure further comprises a patterned surface, and the patterned surface is textured patterns, granular patterns, prisms, microlens or the combination thereof.

3. The backlight module according to claim 1, characterized in that: the substrate is a diffuser plate, a diffuser sheet or a light concentrating sheet.

4. A backlight module, characterized in that: the backlight module comprises:
an optical component comprising:
a substrate having a first surface and a second surface which is opposite to the first surface;
a fluorescent layer formed on the first surface of the substrate; and
a microstructure formed on the second surface of the substrate;
a fixed plate; and
at least one semiconductor light-emitting device fixing on the fixed plate for emitting at least one incident beam;
wherein the at least one incident beam is optically refracted or scattered by the microstructure, so that the at least one incident beam uniformly penetrates through the microstructure and the substrate in turn, and then penetrates through the fluorescent layer or excites the fluorescent layer.

5. The backlight module according to claim 4, characterized in that: the microstructure further comprises a patterned surface, and the patterned surface is textured patterns, granular patterns, prisms, microlens or the combination thereof.

6. The backlight module according to claim 4, characterized in that: the at least one semiconductor light-emitting device is a light-emitting diode chip.

7. The backlight module according to claim 4, characterized in that: the substrate is a diffuser plate, a diffuser sheet or a light concentrating sheet.

8. The backlight module according to claim 4, characterized in that: the at least one incident beam is a blue beam, and the fluorescent layer is a yellow fluorescent layer.

9. The backlight module according to claim 4, characterized in that: the fixed plate is a back plate or a light source base.

10. An optical component comprises, characterized in that: the optical component comprises:
a substrate having a first surface and a second surface;
a fluorescent layer formed on the first surface of the substrate; and
a microstructure formed on the second surface of the substrate for at least one beam to be optically refracted or scattered, so that the at least one beam penetrates through the microstructure and the substrate in turn, and then penetrates through the fluorescent layer or excites the fluorescent layer.

11. The optical component according to claim 10, characterized in that: the microstructure further comprises a patterned surface with textured patterns, granular patterns, prisms, microlens or the combination thereof.

12. The optical component according to claim 10, characterized in that: the substrate is a diffuser plate, a diffuser sheet or a light concentrating sheet.

13. The optical component according to claim 10, characterized in that: the at least one incident beam is a blue beam, and the fluorescent layer is a yellow fluorescent layer.
